(19) United States
(12) Patent Application Publication
(10) Pub. No.: US 2013/0112669 A1
(43) Pub. Date: May 9, 2013

(54) HEAT TREATMENT APPARATUS

(71) Applicants: Takashi UEMURA, Kudamatsu (JP); Kenetsu Yokogawa, Tsurugashima (JP); Masatoshi Miyake, Kamakura (JP); Masaru Izawa, Hino (JP); Satoshi Sakai, Yokohama (JP)

(72) Inventors: Takashi UEMURA, Kudamatsu (JP); Kenetsu Yokogawa, Tsurugashima (JP); Masatoshi Miyake, Kamakura (JP); Masaru Izawa, Hino (JP); Satoshi Sakai, Yokohama (JP)

(21) Appl. No.: 13/354,358

(22) Filed: Jan. 20, 2012

(30) Foreign Application Priority Data
Nov. 8, 2011 (JP) 2011-244083

(51) Int. Cl. B23K 9/00

(52) U.S. Cl. 219/121.36

(57) ABSTRACT

The present invention provides a heat treatment apparatus which can reduce a surface roughing of a processed substrate while keeping a heat efficiency high, even in the case of heating a sample to be heated to 1200° C. or higher. The present invention is a heat treatment apparatus carrying out a heat treatment of a sample to be heated, wherein a plasma generated by a glow electric discharge is used as a heating source, and the sample to be heated is indirectly heated.

### BACKGROUND OF THE INVENTION

(1) Field of the Invention

The present invention relates to a semiconductor manufacturing apparatus which manufactures a semiconductor device, and relates to a heat treatment technology which carries out an activation anneal, a defect recovery anneal, an oxidation of a surface and the like after an impurity doping which is carried out for the purpose of controlling a conduction of a semiconductor substrate.

(2) Description of Related Art

In recent years, it is expected to introduce a new material having a wide band gap such as a silicon carbide (hereinafter, refer to as SiC) or the like as a substrate material for a power semiconductor device. SiC which is a wide band gap semiconductor has a physical property which is more excellent than a silicon (hereinafter, refer to as Si), for example, a high dielectric breakdown electric field, a high saturation electron velocity and a high coefficient of thermal conductivity. Since it is a material having a high dielectric breakdown electric field, a thin film formation and a high concentration dope of an element can be achieved, and it is possible to make an element having a high blocking voltage and a low resistance. Further, since a band gap is great, it is possible to suppress a thermal excitation electron. Further, since a heat dissipation capacity is high on the basis of the high coefficient of thermal conductivity, it is possible to stably operate at a high temperature. Accordingly, if the SiC power semiconductor device is realized, a wide efficiency improvement and a high performance can be expected in various power and electric equipment such as a power transport and conversion, an industrial power apparatus, a household appliance and the like.

A step of manufacturing the various power devices by using the SiC in the substrate is the same as the case that the Si is used in the substrate. However, a heat treatment step can be listed up as a greatly different step. The heat treatment step is represented by an activation annealing after an ion implantation of an impurity which is carried out for the purpose of a conducting property control. In the case of the Si device, the activation annealing is carried out at a temperature between 800 and 1200° C. On the other hand, in the case of the SiC, a temperature between 1200 and 2000° C. is necessary on the basis of its material property.

As an anneal apparatus directed to the SiC substrate, for example, there has been known a resistance heating furnace which is disclosed in patent document (JP-A-2009-32774). Further, in addition to the resistance heating furnace type, for example, there has been known an induction heating type anneal apparatus which is disclosed in patent document 2 (JP-A-2010-34481). Further, a method of installing a lid to which SiC is exposed in a portion facing to the SiC substrate is disclosed as a method of suppressing an SiC surface roughing by the anneal, in patent document 3 (JP-A-2009-231341). Further, in patent document 4 (JP-A-2010-517294), there is disclosed an apparatus for heating a wafer via a metal sheath by an atmospheric plasma which is created by a micro wave.

In the case of carrying out a heating at 1200° C. or higher by the resistance heating furnace described in the patent document 1, the following problems become remarkable.

A first point is a thermal efficiency. Since a radiation become dominant in the heat dissipation from a furnace casing and an amount of radiation is increased in proportion to a fourth-power of a temperature, an energy efficiency required for heating is extremely lowered if a heating area is great. In the case of the resistance heating furnace, in order to avoid a contamination from a heater, a double tube structure is normally used, and a heating area becomes great. Further, since a sample to be heated backs away from a heat source (a heater) due to the double tube, it is necessary to set the heater portion to a high temperature which is higher than the temperature of the sample to be heated, and it comes to a factor lowering the efficiency greatly. Further, a heat capacity of the heated area becomes very large due to a similar reason, and it takes a long time to increase or decrease the temperature. Accordingly, since a time required for carrying the sample to be heated out after carrying it in becomes longer, a throughput is lowered, a time for making the sample to be heated stay under a high temperature environment becomes longer, and it comes to a factor increasing the surface roughing of the sample to be heated mentioned below.

A second point is a consumption of the furnace material. As the furnace material, a material which can correspond to the temperature between 1200 and 2000° C. is limited, and a material having a high melting point and a high purity is necessary. The furnace material which can be made good use for the SiC substrate is a graphite or SiC itself. In general, there is employed a material obtained by coating the SiC on a surface of a SiC sintered body or a graphite base material in accordance with a chemical vapor deposition. They are normally expensive, and in the case that the furnace body is large, a lot of cost is necessary at a time of replacing. Further, since the higher the temperature is, the shorter a service life of the furnace body, a replacing cost becomes higher in comparison with a normal Si process.

A third point is a generation of a surface roughing going with an evaporation of the sample to be heated. In the heating at about 1800° C., the Si is selectively evaporated from the surface of the SiC which is the sample to be heated so as to generate the surface roughing, and the doped impurity falls out, whereby a necessary device property can not be obtained. With respect to the surface roughing of the sample to be heated going with the high temperature or the like, there has been conventionally employed a method of previously forming a carbon film on the surface of the sample to be heated so as to use as a protection film during the heating. However, in this conventional method, it is necessary to form and remove the carbon film in a different step for the heat treatment, a number of the steps is increased and a cost is increased.

On the other hand, the induction heating method described in the patent document 2 is a method of heating by circulating an induction current generated by a radio frequency to a heated subject of an installing means for installing the heated subject, and a heat efficiency becomes higher in comparison with the former resistance heating furnace method. In this case, in the case of the induction heating, if an electric resistivity of the heated subject is low, an induction current necessary for heating is increased, and a heat loss in the induction coil or the like is not negligible. Accordingly, a heating efficiency with respect to the heated subject is not necessarily high.

Further, in the induction heating method, since a heating uniformity is defined on the basis of the induction current which circulates in the sample to be heated or the installing means for installing the heated subject, there is a case that the heating uniformity can not be sufficiently obtained in a flat disc which is used for manufacturing a device. If the heating uniformity is not good, there is a risk that the sample to be heated is broken due to a heat stress at a time of rapidly heating. Accordingly, due to a necessity for setting a speed of a temperature rising to such a degree that a stress is not generated, it becomes a factor of lowering a throughput. Further, in the same manner as the resistance furnace heating method, a step of creating and removing a cap film for preventing the Si evaporation from the SiC surface at a time of a very high temperature is independently necessary.

Further, in the method of preventing the SiC surface roughing which is disclosed in the patent document 3, since an Si atomic element breaks away from the SiC substrate surface under a high temperature environment, however, the Si atomic element is also evaporated from the opposed surface, thereby preventing the surface roughing of the SiC substrate surface by incorporating the Si atomic element discharged from the opposed surface into the portion in the SiC substrate surface after the Si breaks away therefrom. In accordance with this, a lid disclosed in the patent document 3 is no more than used as a feed source of the Si atomic element, in the heating by the induction heating coil or the resistance heating heater.

Further, in the anneal apparatus disclosed in the patent document 4, the heating source is the atmospheric pressure plasma which is created by the micro wave, however, since an area in which the plasma is created is great, a heating efficiency is deteriorated.

Further, in the case that the heating source uses the plasma, if the plasma is directly exposed to the sample to be heated so as to heat, a kinetic energy applying a damage to a crystal surface is generally equal to or more than 10 electron volt. Since a damage is applied if an acceleration of an iron going beyond this value is generated, it is necessary to make the energy of the ion which incomes to the sample to be heated, equal to or less than 10 electron volt. In accordance with this, a creating condition of the plasma is restricted.

### BRIEF SUMMARY OF THE INVENTION

The present invention is made by taking the problem mentioned above into consideration, and provides a heat treatment apparatus which can reduce a surface roughing of a processed substrate while keeping a heat efficiency high, even in the case of heating a sample to be heated to 1200° C. or higher.

The present invention is a heat treatment apparatus carrying out a heat treatment of a sample to be heated, wherein a plasma generated by a glow electric discharge is used as a heating source, and the sample to be heated is indirectly heated.

In the heat treatment apparatus in accordance with the present invention, it is preferable that a heating treatment chamber for heating the sample to be heated is provided, and the heating treatment chamber is provided with a heating plate, an electrode which is opposed to the heating plate, and a radio-frequency power supply which feeds a radio-frequency power for creating the plasma to the electrode.

In the heat treatment apparatus in accordance with the present invention, it is preferable that the heating treatment chamber is provided further with a radiation heat suppressing means which suppresses a radiation heat.

In the heat treatment apparatus in accordance with the present invention, it is preferable that the heating plate is constructed by a disc-like member and a beam which is provided in an outer periphery of the member, and the heating plate is fixed by the beam.

In the heat treatment apparatus in accordance with the present invention, it is preferable that the heating treatment chamber is separated into a plasma creating chamber which creates the plasma and a heating chamber which heats up the sample to be heated, by the heating plate.

In the heat treatment apparatus in accordance with the present invention, it is preferable that the radiation heat suppressing means is constructed by a sheet material which has a high melting point and a low radiation rate or a coating which has a high melting point and a low radiation rate.

### EFFECT OF THE INVENTION

The present invention can reduce a surface roughing of the treated substrate while keeping a heat efficiency high.

Other objects, features and advantages of the invention will become apparent from the following description of the embodiments of the invention taken in conjunction with the accompanying drawings.

### BRIEF DESCRIPTION OF THE SEVERAL VIEWS OF THE DRAWING

FIG. 1 is a view of a basic structure of a heat treatment apparatus in accordance with an embodiment 1;

FIG. 2 is a top elevational view as seen from a cross section AA of a heating treatment chamber of the heat treatment apparatus in accordance with the embodiment 1;

FIG. 3 is an enlarged view of a heating area in the heating treatment chamber of the heat treatment apparatus in accordance with the embodiment 1;

FIG. 4 is a view explaining a carrying in and out the heat treatment apparatus in accordance with the embodiment 1 to the heating treatment chamber;

FIG. 5 is a view of a basic structure of a heat treatment apparatus in accordance with an embodiment 2;

FIG. 6 is a view of a basic structure of a heat treatment apparatus in accordance with an embodiment 3; and

FIG. 7 is a top elevational view as seen from a cross section BB of a heating treatment chamber of the heat treatment apparatus in accordance with the embodiment 3.

### DETAILED DESCRIPTION OF THE INVENTION

A description will be given below of each of embodiments in accordance with the present invention with reference to the accompanying drawings.

### Embodiment 1

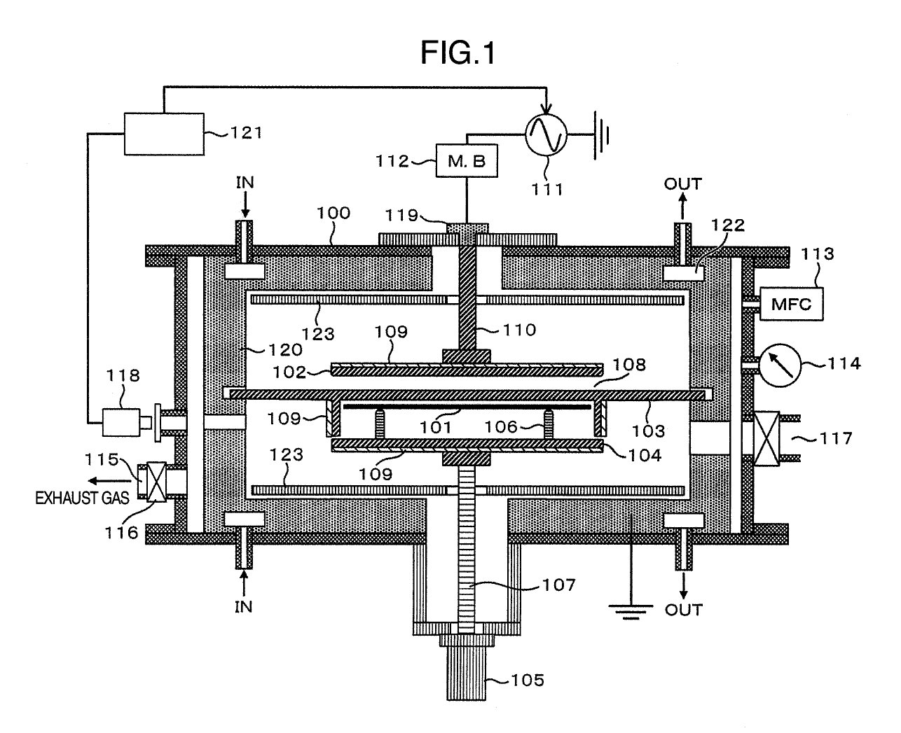

A description will be given of a basic structure in a heat treatment apparatus in accordance with the present invention by using FIG. 1.

The heat treatment apparatus in accordance with the present invention is provided with a heating treatment chamber 100 which heats up a sample to be heated 101 by using a plasma 124.

The heating treatment chamber 100 is provided with an upper electrode 102, a lower electrode 103 which is opposed to the upper electrode 102 and corresponds to a heating plate, a sample bed plate 104 which has a support pin supporting the sample to be heated 101, a reflection mirror 120 which reflects a radiation heat, a radio-frequency power supply 111 which feeds a radio-frequency power for creating a plasma to the upper electrode 102, a gas introducing means 113 which feeds a gas into the heating treatment chamber 100, and a vacuum valve 116 which regulates a pressure within the heating treatment chamber 100.

The sample to be heated 101 is supported on the support pin 106 of the sample bed plate 104, and comes close to a lower side of the lower electrode 103. Further, the lower electrode 103 comes into contact with the reflection mirror 120 in its outer periphery, and does not come into contact with the sample to be heated 101 and the sample bed plate 104. In the present embodiment, 4 inch (φ100 mm) SiC substrate is used as the sample to be heated 101. Diameters and thicknesses of the upper electrode 102 and the sample bed plate 104 are respectively set to 120 mm and 5 mm.

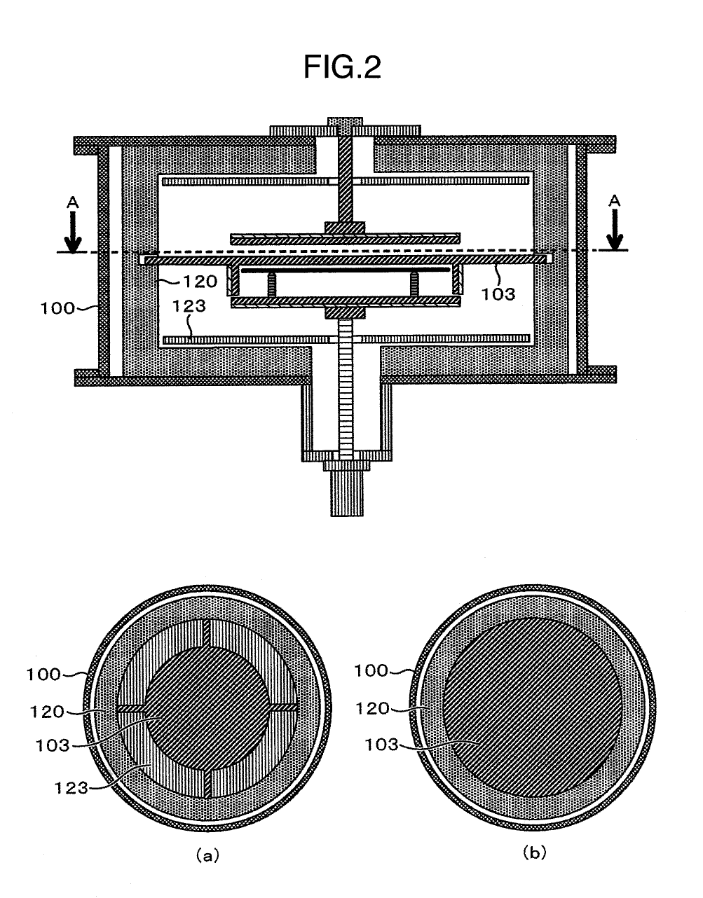

On the other hand, a diameter of the lower electrode 103 is equal to or more than an inner diameter of the reflection mirror 120, and a thickness thereof is set to 2 mm. Further, the lower electrode 103 has a member which covers a side surface of the sample to be heated 101 and has an inner tube shape, in an opposite side to a surface which is opposed to the upper electrode 102. A front elevational view seeing a cross section AA from the above is shown in FIG. 2. The lower electrode 103 is constructed by a disc-like member in which a diameter is approximately the same as the upper electrode 102, and four beams which connect the disc-like member and the reflection mirror 120 and are arranged at a uniform distance, as shown in (a) of FIG. 2. In this case, a number, a cross section and a thickness of the beams mentioned above may be determined by taking into consideration a strength of the lower electrode 103 and a heat dissipation from the lower electrode 103 to the reflection mirror 120.

Since the lower electrode 103 has a structure shown in (a) of FIG. 2, it can inhibit the heat of the lower electrode 103 which is heated by the plasma 124 from being transferred to the reflection mirror 120. Accordingly, it serves as a heating plate having a high heat efficiency. In this case, the plasma 124 which is created between the upper electrode 102 and the lower electrode 103 is diffused to a side of the vacuum valve 116 from a space between the beam and the beam, however, since the sample to be heated 101 is covered by the member having the inner tube shape mentioned above, the sample to be heated 101 is not exposed to the plasma 124.

Further, if the lower electrode 103 is structured as shown in (b) of FIG. 2, the heating treatment chamber 100 can be separated into a plasma creating chamber which creates the plasma 124, and a heating chamber which heats up the sample to be heated 101. Accordingly, the sample to be heated 101 is not exposed to the plasma 124, and it is possible to fill a gas for creating the plasma 124 only in the plasma creating chamber. In accordance with this, it is possible to save a consumption of the gas on the basis of the structure of the lower electrode 103 in accordance with the present embodiment. However, as mentioned above, in the function as the heating plate, the structure of the lower electrode 103 in accordance with the present embodiment is more excellent than the structure in (b) of FIG. 2.

Further, the upper electrode 102, the lower electrode 103, the sample 104 and the support pin 106 employ ones obtained by depositing SiC on a surface of a graphite substrate in accordance with a chemical vapor deposition (hereinafter, refer to as CVD method).

Further, a gap 108 between the lower electrode 103 and the upper electrode 102 is set to 0.8 mm. In this case, the sample to be heated 101 is provided with a thickness between about 0.5 mm and 0.8 mm, and a corner portion of a circumference in an opposed side of each of the upper electrode 102 and the lower electrode 103 is processed as a taper shape or a round shape. This is for the purpose of suppressing a plasma localization caused by an electric field concentration in the corner portion of each of the upper electrode 102 and the lower electrode 103.

The sample bed plate 104 is connected to an elevating mechanism 105 via a shaft 107, and it is possible to transfer the sample to be heated 101 and move the sample to be heated 101 close to the lower electrode 103 by actuating the elevating mechanism 105. In this case, details thereof will be described later. Further, an alumina material is used for the shaft 107.

A radio-frequency power is fed to the upper electrode 102 from a radio-frequency power supply 111 via an upper feeder line 110. In the present embodiment, 13.56 MHz is employed as a frequency of the radio-frequency power supply 111. The lower electrode 103 is conducted with the reflection mirror 120 via the beam. Further, the lower electrode 103 is grounded via the reflection mirror 120. The upper feeder line 110 is also formed by a graphite which is a constructing material of the upper electrode 102 and the lower electrode 103.

A matching circuit 112 (in this case, reference symbol M.B in FIG. 1 is short for a matching box) is arranged between the radio-frequency power supply 111 and the upper electrode 102, and is structured such as to efficiently feed the radio-frequency power from the radio-frequency power supply 111 to the plasma 124 which is formed between the upper electrode 102 and the lower electrode 103.

It is structured such that a gas can be introduced into the heating treatment chamber 100 in which the upper electrode 102 and the lower electrode 103 are arranged, in a range between 0.1 atm and 10 atm by a gas introducing means 113. The pressure of the introduced gas is monitored by a pressure detecting means 114. Further, the heating treatment chamber 100 is structured such that the gas can be discharged by a vacuum pump which is connected to an exhaust port 115 and a vacuum valve 116.

The upper electrode 102, the lower electrode 103 and the sample bed plate 104 within the heating treatment chamber 100 are structured such as to be surrounded by the reflection mirror 120. The reflection mirror 120 is constructed by optically polishing an inner wall surface of a metal base material and plating or depositing a gold on the polished surface. Further, a cooling medium flow path 122 is formed in the metal base material of the reflection mirror 120, and is structured such that a temperature of the reflection mirror 120 can be kept constant by circulating a cooling water. Since a radiation heat from the upper electrode 102, the lower electrode 103 and the sample bed plate 104 can be reflected on the basis of the provision of the reflection mirror 120, it is possible to enhance a thermal efficiency, however, it is not an essential structure of the present invention.

Further, a protection quartz plate 123 is arranged between the upper electrode 102 and the sample bed plate 104, and the reflection mirror 120. The protection quartz plate 123 has a function of preventing the surface of the reflection mirror 120 from being contaminated by a discharged material (a sublimation of a graphite) from the upper electrode 102, the lower electrode 103 and the sample bed plate 104 which are at an ultra-high temperature, and preventing the contamination which may be mixed into the sample to be heated 101 from the reflection mirror 120.

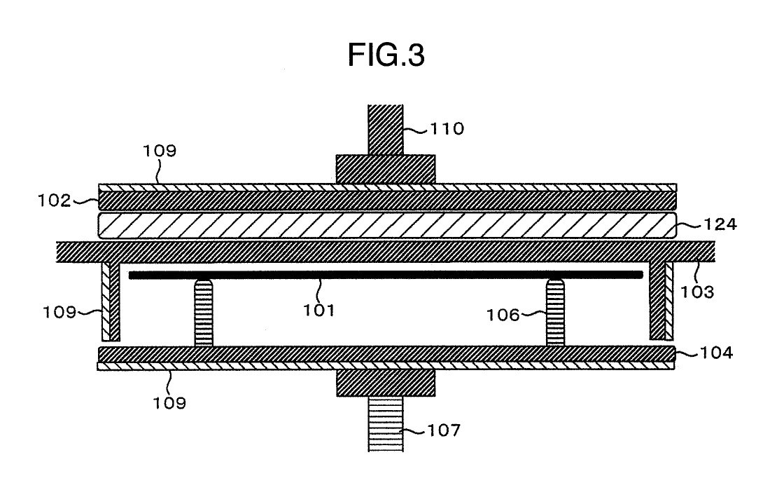

As shown in FIG. 3, a sheet member having a high melting point and a low radiation rate or a coating 109 having a high melting point and a low radiation rate is arranged in an outer side of a member which covers an opposite side of a surface coming into contact with the plasma 124 of the upper electrode 102, and a side surface of the sample to be heated 101 of the lower electrode 103 and has an inner tube shape, and a lower surface side of the sample bed plate 104. Since the radiation heat from the upper electrode 102, the lower electrode 103 and the sample bed plate 104 can be lowered on the basis of the provision of the sheet member having the high melting point and the low radiation rate or the coating having the high melting point and the low radiation rate, it is possible to enhance a heat efficiency.

In this case, in the case that a treating temperature is low, they are not necessarily provided. In the case of the ultra-high temperature treatment, it is possible to heat to a predetermined temperature on the basis of a provision of any one of the sheet member having the high melting point and the low radiation rate or the coating 109 having the high melting point and the low radiation rate and the reflection mirror 120, or on the basis of a provision of both of them. The temperature of the lower electrode 103 or the sample bed plate 104 is measured by a radiation temperature gauge 118. In the present embodiment, a sheet member obtained by coating TaC (a tantalum carbide) on the graphite base material is used for the sheet member having the high melting point and the low radiation rate or the coating 109 having the high melting point and the low radiation rate which is applied to the upper electrode 102, the lower electrode 103 and the sample bed plate 104.

Next, a description will be given of an example of a basic operation of the heat treatment apparatus in accordance with the present invention.

First of all, He gas within the heating treatment chamber 100 is exhausted from the exhaust port 115 so as to form a high vacuum state. In such a state that the exhaust air is sufficiently finished, the exhaust port 115 is closed, the gas is introduced from the gas introducing means 113, and an inner side of the heating treatment chamber 100 is controlled to 0.6 atm. In the present embodiment, He is employed for the gas which is introduced into the heating treatment chamber 100.

The sample to be heated 101 which is preheated at 400° C. in a preheating chamber (not illustrated) is carried from a carrier port 117, and is supported on the support pin 106 of the sample bed plate 104. In this case, a method of supporting the sample to be heated 101 onto the support pin 106 will be in detail mentioned later.

After the sample to be heated 101 is supported on the support pin 106 of the sample bed plate 104, the sample bed plate 104 is raised to a predetermined position by the elevating mechanism 105. In the present embodiment, a position at which a distance between a lower surface of the lower electrode 103 and a surface of the sample to be heated 101 comes to 0.5 mm is set to the predetermined position.

In the present embodiment, a distance between the lower surface of the lower electrode 103 and the surface of the sample to be heated 101 is set to 0.5 mm, however, it may be a distance between 0.1 mm and 2 mm. In this case, the closer the sample to be heated 101 comes to the lower surface of the lower electrode 103, the better the heating efficiency is. However, in accordance that it comes closer, a risk that the lower electrode 103 and the sample to be heated 101 come into contact with each other is enhanced, and a problem of a contamination or the like is generated. Accordingly, 0.1 mm or less is not preferable. Further, in the case that the distance is larger than 2 mm, the heating efficiency is lowered, and the radio-frequency power which is necessary for heating is increased, so that this is not preferable. Therefore, the coming close in the present invention is assumed to be the distance between 0.1 mm and 2 mm.

After the sample bed plate 104 is moved up and down to the predetermined position, the heating of the sample to be heated 101 is carried out by feeding the radio-frequency power from the radio-frequency power supply 111 to the upper electrode 102 via the matching circuit 112 and a power introduction terminal 119, and creating the plasma 124 within the gap 108. An energy of the radio-frequency power is absorbed by an electron within the plasma 124, and an atomic element or a molecule of a raw material gas is heated by a collision of the electrons. Further, an ion generated by an ionization is accelerated by an electric potential difference which is generated in a sheath on the surface which comes into contact with the plasma 124 in the upper electrode 102 and the lower electrode 103, and enters into the upper electrode 102 and the lower electrode 103 while coming into collision with the raw material gas. On the basis of the collision process, it is possible to raise the temperature of the gas which is filled between the upper electrode 102 and the lower electrode 103 and the temperature of the surface between the upper electrode 102 and the lower electrode 103.

Particularly, in the vicinity of the atmospheric pressure such as the present embodiment, since the ion comes into collision with the raw material gas frequently at a time when the ion passes through the sheath, there can be thought that it is possible to efficiently heat the raw material gas which is filled between the upper electrode 102 and the lower electrode 103.

As a result, it is possible to easily heat the temperature of the raw material gas to about 1200 to 2000° C. On the basis of the contact of the heated high temperature gas with the upper electrode 102 and the lower electrode 103, the upper electrode 102 and the lower electrode 103 are heated. Further, a part of a neutral gas which is excited by an electron collision gets out of an excitation while accompanying a light generation, and the upper electrode 102 and the lower electrode 103 are heated by the light generation at this time. Further, the sample bed plate 104 and the sample to be heated 101 are heated by a circulation of the high temperature gas and a radiation from the heated upper electrode 102 and lower electrode 103.

In this case, since the lower electrode 103 corresponding to the heating plate exists so as to be close to an upper side of the sample to be heated 101, the sample to be heated 101 is heated after the lower electrode 103 is heated by the gas which is heated to a high temperature by the plasma 124. Therefore, it is possible to obtain an effect of uniformly heating the sample to be heated 101. Further, on the basis of the provision of the sample bed plate 104 below the lower electrode 103, it is possible to form a uniform electric field between the lower electrode 103 and the upper electrode 102 so as to create a uniform plasma 124. Further, the sample to be heated 101 is not directly exposed to the plasma 124 which is formed in the gap 108, by arranging the sample to be heated 101 below the lower electrode 103. Further, even in the case of changing from a glow electric discharge to an arc electric discharge, the electric discharge current flows to the lower electrode 103 without going through the sample to be heated 101, so that it is possible to avoid a damage applied to the sample to be heated 101.

Since the temperature of the lower electrode 103 or the sample bed plate 104 during the heating treatment is measured by the radiation temperature gauge 118, and an output of the radio-frequency power supply 111 is controlled by a control apparatus 121 while using a measured value in such a manner as to come to a predetermined temperature, it is possible to control the temperature of the sample to be heated 101 at a high precision. In the present embodiment, the input radio-frequency power is set to 20 kW to the maximum.

In order to efficiently raise the temperatures of the upper electrode 102, the lower electrode 103 and the sample bed plate 104 (including the sample to be heated 101), it is necessary to suppress a heat transfer of the upper feeder line 110, a heat transfer via the He gas atmosphere and a radiation from the high temperature region (a visible light region from an infrared light). Particularly, in the ultra-high temperature state equal to or higher than 1200° C., an influence of the heat dissipation by the radiation is very great, and it is essential for improving the heating efficiency to reduced a radiation loss. In this case, in the radiation loss, an amount of radiation is increased in proportion to fourth-power of an absolute temperature.

In order to suppress the radiation loss, in the present embodiment, as mentioned above, the sheet member having the high melting point and the low radiation rate or the coating 109 having the high melting point and the low radiation rate is arranged in the upper electrode 102, the lower electrode 103 and the sample bed plate 104. TaC is used for a material having a high melting point and a low radiation rate. The radiation rate of TaC is about 0.05 to 0.1, and reflects the infrared light going with the radiation at a reflection rate about 90%. Accordingly, the radiation loss from the upper electrode 102, the lower electrode 103 and the sample bed plate 104 can be suppressed by the sheet member having the high melting point and the low radiation rate or the coating 109 having the high melting point and the low radiation rate, and it is possible to set the sample to be heated 101 to the ultra-high temperature about 1200 to 2000° C. at a high heat efficiency.

The TaC is arranged in a state in which it is not exposed directly to the plasma 124, and is structured such that the impurity included in the Ta or the TaC is not mixed into the sample to be heated 101 during the heating treatment. Further, since a heat capacity of the sheet member having the high melting point and the low radiation rate and the coating 109 having the high melting point and the low radiation rate, which is constructed by the TaC is extremely small, it is possible to restrict an increase of the heat capacity of the heating portion to the minimum. In accordance with this, there is hardly generated a reduction of a temperature rising and temperature decreasing speed caused by arranging the sheet member having the high melting point and the low radiation rate or the coating 109 having the high melting point and the low radiation rate.

Further, it is possible to form the plasma 124 which is expanded uniformly between the upper electrode 102 and the lower electrode 103, by forming a plasma 124 of a heating source as a plasma in a glow electric discharge region, and it is possible to uniformly heat a two-dimensional sample to be heated 101 by heating the sample to be heated 101 by using the uniform and two-dimensional plasma 124 as a heat source.

Further, since it is possible to two-dimensionally and uniformly heat up, there is a low risk that a breakage or the like going with the temperature unevenness within the sample to be heated 101 is generated even by raising the temperature rapidly. As mentioned above, it is possible to achieve a temperature rise and a temperature down at a high speed, and it is possible to shorten a time which is necessary for a series of heating treatments. On the basis of this effect, it is possible to improve a throughput of the heating treatment, it is possible to inhibit the sample to be heated 101 from staying in the high temperature atmosphere more than necessary, and it is possible to reduce the SiC surface roughing going with the high temperature.

If the heating treatment mentioned above is finished, the sample to be heated 101 is carried out of the carrier port 117, in a state that the temperature of the sample to be heated 101 is lowered to 800° C. or lower, the next sample to be heated 101 is carried into the heating treatment chamber 100 so as to be supported on the support pin 106 of the sample bed plate 104, and the operations of the heating treatment mentioned above are repeated.

It is possible to reduce an amount of used gas without carrying out a replacement of He within the heating treatment chamber 100 going with the replacement of the sample to be heated 101, by keeping a gas atmosphere at a sample to be heated retracting position (not illustrated) which is connected to the carrier port 117 at the same level as that within the heating treatment chamber 100, at a time of replacing the sample to be heated 101.

Of course, since a purity of the He gas within the heating treatment chamber 100 may be lowered by repeating the heating treatment to some extent, the replacement of the He gas is executed periodically at that time. In the case that the He gas is used for the electric discharge gas, the He gas is a comparative expensive gas, so that a running cost can be held down by reducing the used amount thereof as much as possible. This can be applied to the mount of the He gas which is introduced during the heating treatment, and it is possible to reduce the used amount of the gas by setting a minimum flow rate for keeping the gas purity during the treatment. Further, a cooling time of the sample to be heated 101 can be shortened by introducing the He gas. In other words, it is possible to shorten the cooling time on the basis of the cooing effect of the He gas by increasing the flow rate of the He gas after the heating treatment is finished (the electric discharge is finished).

In this case, in the above, the sample to be heated 101 is carried out in a state of being equal to or less than 800° C., however, even if the sample to be heated 101 is in a state between 800° C. and 2000° C., it is possible to carry out by using a carrier arm having a high heat resistance, whereby it is possible to shorten a standby time.

In the present embodiment, the gap 108 between the upper electrode 102 and the lower electrode 103 is set to 0.8 mm, however, the same effect can be achieved even in a range between 0.1 mm and 2 mm. The electric discharge can be achieved even in the case that the gap is narrower than 0.1 mm, however, a high precision function is necessary for maintaining a degree of parallelization between the upper electrode 102 and the lower electrode 103. Further, since a surface transformation (a surface roughing or the like) of the upper electrode 102 and the lower electrode 103 is going to affect the plasma 124, this is not preferable. On the other hand, in the case that the gap 108 goes beyond 2 mm, a reduction of a flammability of the plasma 124 and a radiation loss increase between the gaps come into question, and this is not preferable.

In the present embodiment, the pressure within the heating treatment chamber 100 for creating the plasma is set to 0.6 atm, however, the same operations can be carried out even at the atmospheric pressure which is equal to or less than 10 atm. In this case, if the pressure goes beyond 10 atm, it is hard to create the uniform glow electric discharge.

In the present embodiment, the He gas is used for the raw material gas for creating the plasma, however, it goes without saying that the same effect can be achieved even by using a gas including an inert gas such as Ar, Xe, Kr or the like as a main raw material. The He gas used in the present embodiment is excellent in a plasma flammability and a stability in the vicinity of the atmospheric pressure, however, the coefficient of thermal conductivity is high, and a heat loss caused by the heat transfer via the gas atmosphere is comparatively great. On the other hand, in the gas having a great mass such as Ar, Xe, Kr gas or the like, since the coefficient of thermal conductivity is low, it is more advantageous than the He gas in the light of the heat efficiency.

In the present embodiment, the material obtained by coating the TaC (tantalum carbide) on the graphite base material is used for the sheet member having the high melting point and the low radiation rate or the coating 109 having the high melting point and the low radiation rate, which is applied to the upper electrode 102, the lower electrode 103 and the sample bed plate 104, however, the same effect can be obtained by using WC (tungsten carbide), MoC (molybdenum carbide), Ta (tantalum), Mo (molybdenum), or W (tungsten).

In the present embodiment, there is employed the graphite obtained by coating the silicon carbide in accordance with the CVD method on the opposite side to the surface which comes into contact with the plasma 124 in the upper electrode 102, the lower electrode 103 and the sample bed plate 104, however, the same effect can be obtained by using a graphite simple substance, a member coating a pyrolytic carbon on the graphite, a member vitrifying the graphite surface, and SiC (sintered body, a polycrystal, a single crystal). In the coating applied to the graphite coming to the base material of the upper electrode 102 and the lower electrode 103 or their surface, it goes without saying that one having a high purity is desirable in the light of preventing the contamination to the sample to be heated 101.

Further, in the present embodiment, the TaC is employed in the sheet member having the high melting point and the low radiation rate or the coating 109 having the high melting point and the low radiation rate, however, the same effect can be obtained by the other materials having a high melting point (a melting point which can stand up to the used temperature) and a low radiation rate. For example, the same effect can be obtained by Ta (tantalum) simple substance, Mo (molybdenum), W (tungsten), WC (tungsten carbide) and the like.

Further, at a time of the ultra-high temperature, there is a case that the contamination to the sample to be heated 101 affects from the upper feed line 110. Accordingly, in the present embodiment, the same graphite as the upper electrode 102 and the lower electrode 103 is used in the upper feed line 110. Further, the heat of the upper electrode 102 is transferred to the upper feed line 110 so as to come to a loss. Accordingly, it is necessary to minimize the heat transfer from the upper feed line 110.

Accordingly, it is necessary to make the cross sectional area of the upper feed line 110 which is formed by the graphite as small as possible, and make the length thereof long. However, if the cross sectional area of the upper feed line 110 is made extremely small, and the length is made too long, the radio-frequency power loss in the upper feed line 110 becomes large, thereby causing a reduction of a heating efficiency of the sample to be heated 101. In accordance with this, in the present embodiment, the cross sectional area of the upper feed line 110 formed by the graphite is set to 12 mm², and the length is set to 40 mm, in the light mentioned above. The same effect can be obtained in such a range that the cross sectional area of the upper feed line 110 is between 5 mm² and 30 mm², and the length of hte4 upper feed line 110 is between 30 mm and 100 mm.

Further, the heat of the sample table 104 is transmitted through the shaft 107 so as to come to a loss. Accordingly, it is necessary to minimize the heat transmission from the shaft 107 in the same manner as the upper feed line 110 mentioned above. Therefore, it is necessary to make the cross sectional area of the shaft which is formed by the alumina material as small as possible, and make the length longer. In the present embodiment, taking a strength or the like into consideration, the cross sectional area and the length of the shaft 107 which is formed by the alumina material are made the same as the upper feed line 110 mentioned above.

In the present embodiment, it is possible to obtain an improvement of the heating efficiency by returning the radiation light to the upper electrode 102, the lower electrode 103 and the sample bed plate 104 by the reflection mirror 120 as well as reducing the radiation loss from the upper electrode 102, the lower electrode 103 and the sample bed plate 104 by the sheet member having the high melting point and the low radiation rate or the coating 109 having the high melting point and the low radiation rate. However, it goes without saying that it is possible to expect the improvement of the heating efficiency, even in the case that only the sheet member having the high melting point and the low radiation rate or the coating 109 having the high melting point and the low radiation rate is applied to the upper electrode 102, the lower electrode 103 and the sample bed plate 104. In the same manner, even in the case that only the reflection mirror 120 is installed, it is possible to expect the improvement of the heating efficiency. Further, the protection quartz plate 123 is installed for expecting the effect of preventing the contamination, and it is possible to obtain a sufficient heating efficiency without using the protection quartz plate 123.

In the present embodiment, the heat dissipation from the upper electrode 102, the lower electrode 103 and the sample bed plate 104, which affects the heating efficiency as mentioned above is manly constructed by (1) the radiation, (2) the heat transmission of the gas atmosphere and (3) the heat transmission from the upper feeder line 110 and the shaft 107. In the case that the heating treatment is carried out at 1200° C., the main factor of the heat dissipation among them is (1) the radiation. In order to suppress (1) the radiation, the sheet member having the high melting point and the low radiation rate or the coating 109 having the high melting point and the low radiation rate is provided in an opposite side to the surface which comes into contact with the plasma 124 in the upper electrode 102, the lower electrode 103 and the sample bed plate 104. Further, the heat dissipation from the upper feeder line 110 and the shaft 107 in the item (3) is minimized by optimizing the cross sectional area and the length of the upper feeder line 110 and the shaft 107, as mentioned above.

Further, with regard to the item (2) the heat transmission of the gas atmosphere, it is suppressed by optimizing a heat transmission distance of the gas. In this case, the heat transmission distance of the gas means a distance from the upper electrode 102, the lower electrode 103 and the sample bed plate 104 thereof which correspond to the high temperature portion to the shield (the protection quartz plate 123) which corresponds to the low temperature portion or the wall of the heating treatment chamber 100 which corresponds to the low temperature portion. Since the heat transmission rate of the He gas is high in the He gas atmosphere in the vicinity of the atmospheric pressure, the heat dissipation by the heat transmission of the gas becomes comparatively higher. Accordingly, in the present embodiment, it is structured such as to secure 30 mm or more in the distance from the upper electrode 102 and the sample bed plate 104 to the shield (the protection quartz plate 123) or the wall of the heating treatment chamber 100. The longer heat transmission distance of the gas is advantageous for suppressing the heat dissipation, however, if the heat transmission distance of the gas is too long, the magnitude of the heating processing chamber 100 becomes larger with respect to the heating region, and this is not preferable. By making the heat transmission distance of the gas equal to or more than 30 mm, it is possible to suppress the heat dissipation caused by the heat transmission of the gas atmosphere while suppressing the magnitude of the heating treatment chamber 100. Of course, it goes without saying that it is possible to further suppress the heat dissipation caused by the heat transmission of the gas atmosphere by using the Ar, Xe, Kr gas or the like having the low coefficient of thermal conductivity.

In the present embodiment, the radio-frequency power supply of 13.56 MHz is used for the radio-frequency power supply for creating the plasma, however, this is because 13.56 MHz is an industrial frequency and the power supply can be obtained at a low cost, and since an electromagnetic wave leakage standard is low and a cost for the apparatus can be reduced. However, in principle, it goes without saying that the heating treatment can be carried out in accordance with the same principle in the other frequency. Particularly, the frequency which is equal to or more than 1 MHz and equal to or less than 100 MHz is preferable. If the frequency becomes lower than 1 MHz, the radio-frequency voltage at a time of feeding the electric power which is necessary for the heating treatment becomes high, there is generated an abnormal electric discharge (an unstable plasma or the other electric discharge than one between the upper electrode and the lower electrode), and it becomes hard to stably create the plasma. Further, in the frequency which goes beyond 100 MHz, since an impedance between the gaps 108 of the upper electrode 102 and the lower electrode 103 is low, and the electric voltage which is necessary for creating the plasma is hard to be obtained, this is not desirable.

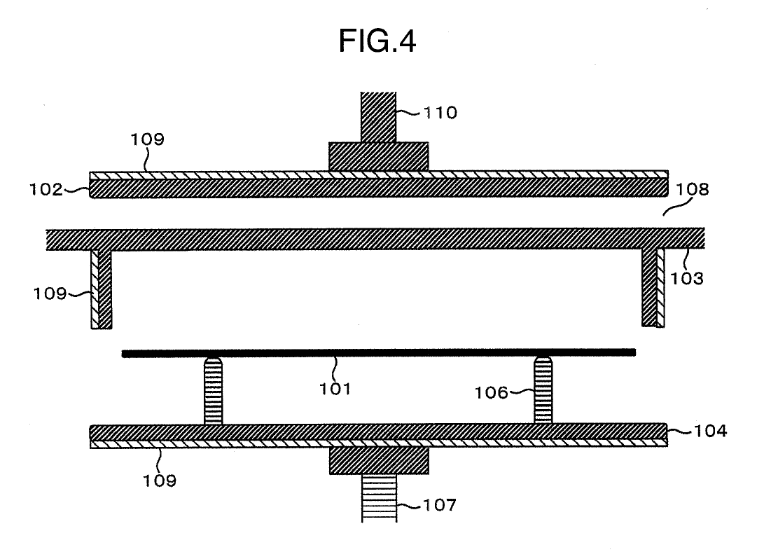

Next, a description will be given of a method of carrying the sample to be heated 101 in and out of the heating treatment chamber 100 with reference to FIG. 3 and FIG. 4. In this case, FIG. 3 and FIG. 4 are detailed views of the heating area of the heating treatment chamber 100. FIG. 3 shows a state during the heating treatment, and FIG. 4 shows a state at a time of carrying in and out the sample to be heated 101.

In the case of carrying out the sample to be heated 101 which is supported on the support pin 106 of the sample bed plate 104, the gap is formed between the sample to be heated 101 and the sample bed plate 104 as shown in FIG. 4, by stopping the plasma 124 from the heating treatment state in FIG. 3, and taking down the position of the sample bed plate 104 by the elevating mechanism 105. The sample to be heated 101 is delivered to a carrier arm (not illustrated) by inserting the carrier arm horizontally to the gap from a carrier port 117 and taking down the elevating mechanism 105, and can be carried out. Further, in the case of carrying the sample to be heated 101 in the heating treatment chamber 100, it is possible to carry the sample to be heated 101 in the heating treatment chamber 100 by carrying out a reverse motion to the carrying out of the sample to be heated mentioned above.

In a state of taking down the support pin 106 of the sample bed plate 104 by the elevating mechanism 105, the sample to be heated 101 is carried onto the support pin 106 by the carrier arm (not illustrated) which mounts the sample to be heated 101 thereon. Thereafter, the sample bed plate 104 is moved up by the elevating mechanism 105, and the sample bed plate 104 receives the sample to be heated 101 from the carrier arm. Further, it is possible to make the sample to be heated 101 close to the below of the lower electrode 103 which corresponds to the heating plate, by moving up the sample bed plate 104 to a predetermined position for carrying out the heating treatment.

Further, in the present embodiment, since the upper electrode 102 and the lower electrode 103 are fixed, the gap 108 does not fluctuate. In accordance with this, it is possible two create a stable plasma 124 every time of the heating treatment of the sample to be heated 101.

As a result that the heat treatment for one minute is carried out at 1500° C., in the SiC substrate in which the ion implantation is carried out by using the heat treatment apparatus in accordance with the present embodiment mentioned above, a good conducting property can be obtained. Further, the surface roughing is not seen on the surface of the SiC substrate.

The effect of the present invention shown in the present embodiment will be arranged below. In the heating treatment in accordance with the present invention, the sample to be heated 101 is heated by using the gas heating caused by the atmospheric pressure glow electric discharge which is created in the narrow gap as the heat source. It is possible to obtain five effects which are not provided by the prior art and shown below, in accordance with the present heating principle.

A first point is a heat efficiency. The heat capacity of the gas in the gap 108 is extremely small, and it is possible to heat the sample to be heated 101 in accordance with the system which the heating loss going with the radiation is extremely small, by arranging the sheet member having the high melting point and the low radiation rate or the coating 109 having the high melting point and the low radiation rate in the upper electrode 102, the lower electrode 103 and the sample bed plate 104.

A second point is a heating response and a uniformity. Since the heat capacity of the heating portion is extremely small, rapid temperature increase and decrease can be achieved. Further, since the gas heating caused by the glow electric discharge is used for the heating source, it is possible to achieve a two-dimensionally uniform heating in the basis of an expansion of the glow electric discharge. Since the temperature uniformity is high, it is possible to suppress the device characteristic dispersion in the surface of the sample to be heated 101 going with the heating treatment, and it is possible to suppress a damage due to a thermal stress going with the temperature difference within the surface of the sample to be heated 101 at a time of carrying out the rapid temperature increase or the like.

A third point is a reduction of the consumed parts going with the heating treatment. In the present invention, since the gas coming into contact with each of the upper electrode 102 and the lower electrode 103 is directly heated, the high temperature forming area is limited to the member which is arranged extremely in the vicinity of the upper electrode 102 and the lower electrode 103, and the temperature thereof is equal to the sample to be heated 101. Accordingly, a service life of the member is short, and the area of replacement going with the parts deterioration is small.

A fourth point is a suppression of the surface roughing of the sample to be heated 101. In the present invention, since the temperature increasing and decreasing times can be made short on the basis of the previously described effect, it is possible to shorten a time for which the sample to be heated 101 is exposed to the high temperature environment to the minimum. Accordingly, it is possible to suppress the surface roughing. Further, in the present invention, the plasma 124 caused by the atmospheric pressure glow electric discharge is used as the heating source, however, the sample to be heated 101 is not directly exposed to the plasma 24. In accordance with this, forming and removing steps of the protection film which are carried out by the different apparatus from the heat treatment apparatus is not necessary, and it is possible to reduce a manufacturing cost of the semiconductor device using the SiC substrate.

A fifth point is a simplification of the carrying of the sample to be heated 101 in and out of the heating treatment chamber 100. In the present invention, it is possible to deliver the sample to be heated 101 from the carrier arm (not illustrated) to the sample bed plate 104 or deliver the sample to be heated 101 from the sample bed plate 104 to the carrier arm (not shown), only by the operation of the elevating mechanism in the sample bed plate 104. Further, since a complicated mechanism for carrying out the delivering mentioned above is not necessary, it is possible to reduce the number of the constructing parts in the heating treatment chamber 100 and it is possible to obtain a simple apparatus structure.

Next, a description will be given of a heat treatment apparatus in which a preheating chamber 200 is arranged further in the heat treatment apparatus in accordance with the present embodiment.

### Embodiment 2

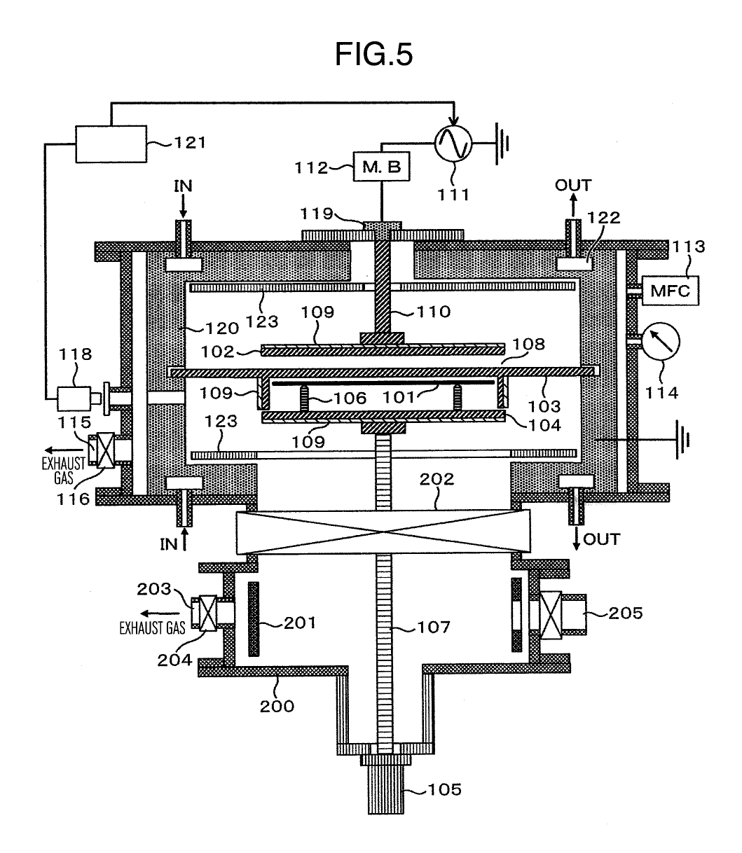

FIG. 5 is a view showing a basic structure in which the preheating chamber 200 is arranged further in the heat treatment apparatus in accordance with the embodiment 1.

In this case, since the elements to which the same reference numerals as those of the embodiment 1 in FIG. 5 have the same functions as the embodiment 1, a description thereof will be omitted.

The heat treatment apparatus in accordance with the present embodiment is structured such that a preheating chamber 200 is connected to the below of the heating treatment chamber 100 via a gate valve 202. Each of the heating treatment chamber 100 and the preheating chamber 200 is occluded in an airtight manner by closing the gate valve 202. Further, the heating treatment chamber 100 and the preheating chamber 200 are communicated by opening the gate valve 202.

Further, the preheating chamber 200 is exhausted by a vacuum pump (not illustrated) which is connected to an exhaust port 203 and a vacuum valve 204.

The sample to be heated 101 is structured such that the sample to be heated 101 is carried in the preheating chamber 200 from a carrier port 205 and the delivery of the sample to be heated 101 is carried out from the carrier arm (not illustrated) onto the support pin 106 of the sample bed plate 104, in the same manner as the method of carrying in and out mentioned in the embodiment 1.

The sample to be heated 101 supported onto the support pin is heated to a desired temperature by a heated 201. In the present embodiment, the sample to be heated 101 is heated up to 400° C. Next, the elevating mechanism 105 is moved up as well as the gate valve 202 is opened, and the sample to be heated 101 heated up to the desired temperature is carried in the heating treatment chamber 101 so as to be carried out the heating treatment.

In accordance with the present embodiment, since it is possible to obtain the same effects as the embodiment 1, and it is possible to shorten the heating treatment time in the heating treatment chamber 100, it is possible to improve a service life of the consumed members within the heating treatment chamber 100.

Next, a description will be given below of an embodiment in accordance with the present invention in which the upper electrode 102 and the lower electrode 103 mentioned above in the embodiment 1 are respectively set to an upper electrode 303 which corresponds to a heating plate, and a lower electrode 302 which is fed a radio-frequency power for creating the plasma.

### Embodiment 3

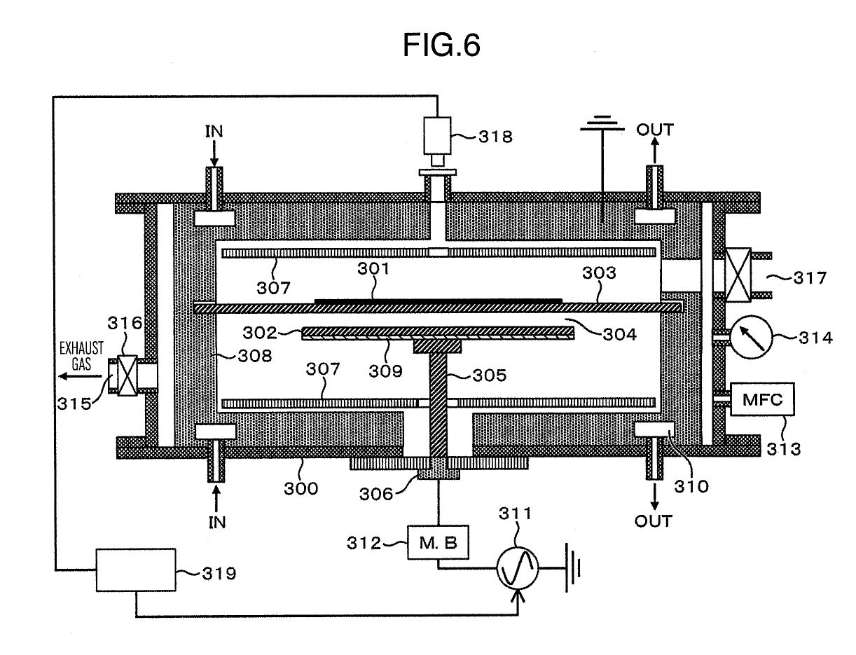

A description will be given of a basics structure in the heating treatment apparatus in accordance with the present invention with reference to FIG. 6.

The heating treatment apparatus in accordance with the present invention is provided with a heating treatment chamber 300 which heats a sample to be heated 301 by using a plasma.

The heating treatment chamber 300 is provided with an upper electrode 303 which mounts the sample to be heated 301 on an upper surface and corresponds to a heating plate, a lower electrode 302 which is opposed to the upper electrode 303, a reflection mirror 308 which reflects a radiation heat, a radio-frequency power supply 311 which feeds a radio-frequency power for creating the plasma, a gas introducing means 313 which feeds a gas into the heating treatment chamber 100, and a vacuum valve 316 which regulates the pressure within the heating treatment chamber 100.

In the present embodiment, a SiC substrate of 4 inch (φ100 mm) is used as the sample to be heated 301.

A diameter and a thickness of the lower electrode 302 are respectively set to 120 mm and 5 mm. The lower electrode 302 and the upper electrode 303 employ the structures which are obtained by piling the SiC on the surface of the graphite substrate in accordance with the CVD method. A gap 304 between the lower electrode 302 and the upper electrode 303 is set to 0.8 mm.

On the other hand, a diameter of the upper electrode is equal to or less than an inner diameter of the reflection mirror 308, and a thickness thereof is set to 2 mm, and the upper electrode 303 mounts the sample to be heated 301 on an upper surface thereof, and transmits the heat of the upper electrode 303 which is heated by the plasma created between the upper electrode 303 and the lower electrode 302 to the sample to be heated. In other words, the upper electrode 303 also plays a part of the heating plate with respect to the sample to be heated 301.

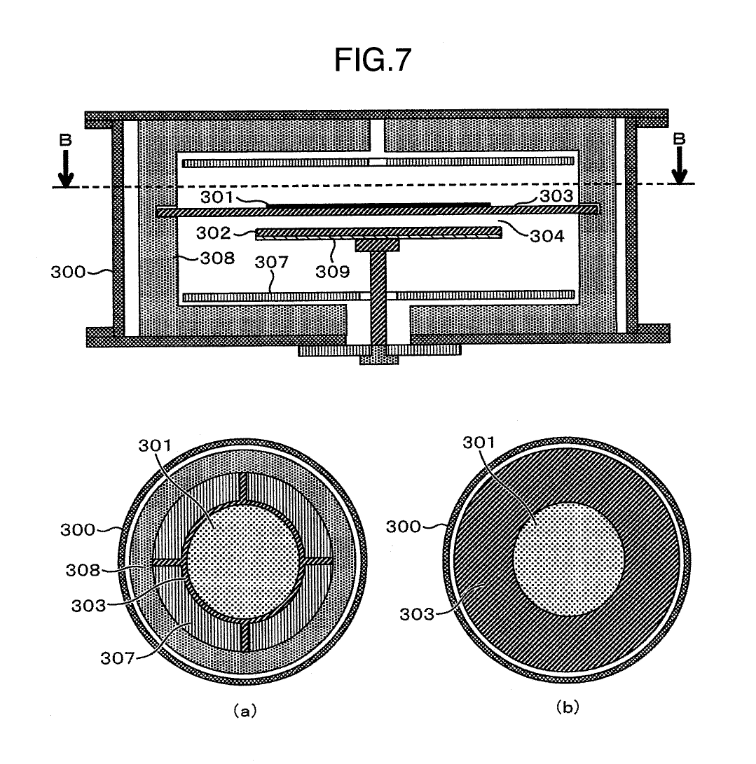

A front elevational view as seeing a cross section BB from the above is shown in FIG. 7. The upper electrode 303 is constructed by a disc-like member in which a diameter is approximately the same as the lower electrode 302, and four beams which connect the disc-like member mentioned above and the reflection mirror 308 and are arranged at uniform intervals, as shown in (a) of FIG. 7. In this case, a number, a cross sectional area and a thickness of the beams mentioned above may be determined by taking into consideration a strength of the upper electrode 303, and a heat dissipation to the reflection mirror 308 from the upper electrode 303.

Since the upper electrode 303 in accordance with the present embodiment has a structure shown in (a) of FIG. 7, it can inhibit the heat of the upper electrode 303 which is heated by the plasma from being transferred to the reflection mirror 308. Accordingly, it serves as a heating plate having a high heat efficiency. In this case, the plasma which is created between the upper electrode 303 and the lower electrode 302 is diffused from a space between the beam and the beam, however, since most of the plasma is diffused to a side of the vacuum valve 316 from a portion between the upper electrode 303 and the lower electrode 302, the sample to be heated 301 is hardly exposed to the plasma.

Further, if the upper electrode 303 is structured as shown in (b) of FIG. 7, the heating treatment chamber 300 can be separated into a plasma creating chamber which creates the plasma, and a heating chamber which heats up the sample to be heated 301. Accordingly, the sample to be heated 301 is not exposed to the plasma, and it is possible to fill a gas for creating the plasma only in the plasma creating chamber. In accordance with this, it is possible to save a consumption of the gas on the basis of the structure of the upper electrode 303 in accordance with the present embodiment. However, as mentioned above, in the function as the heating plate, the structure of the upper electrode 303 in accordance with the present embodiment is more excellent than the structure in (b) of FIG. 7.

A radio-frequency power is fed to the lower electrode 302 from a radio-frequency power supply 311 via a lower feeder line 305. In the present embodiment, 13.56 MHz is employed as a frequency of the radio-frequency power supply 311. The upper electrode 303 is conducted with the reflection mirror 308 in an outer periphery, and the upper electrode 303 is grounded via the reflection mirror 308. The lower feeder line 305 is also formed by a graphite which is a constructing material of the lower electrode 302 and the upper electrode 303.

A matching circuit 312 (in this case, reference symbol M.B in FIG. 6 is short for a matching box) is arranged between the radio-frequency power supply 311 and the lower electrode 302, and is structured such as to efficiently feed the radio-frequency power from the radio-frequency power supply 311 to the plasma which is formed between the lower electrode 302 and the upper electrode 303.

It is structured such that a gas can be introduced into the heating treatment chamber 300, in a range between 0.1 atm and 10 atm by a gas introducing means 313. The pressure of the gas introduced into the heating treatment chamber 300 is monitored by a pressure detecting means 314. Further, the heating treatment chamber 300 is exhausted by a vacuum pump (not illustrated) which is connected to an exhaust port 315 and a vacuum valve 316.

The lower electrode 302 and the upper electrode 303 within the heating treatment chamber 300 are structured such as to be surrounded by the reflection mirror 308. The reflection mirror 308 is constructed by optically polishing an inner wall surface of a metal base material and plating or depositing a gold on the polished surface. Further, a cooling medium flow path 310 is formed in the metal base material of the reflection mirror 308, and is structured such that a temperature of the reflection mirror 308 can be kept constant by circulating a cooling water. Since a radiation heat from the lower electrode 302 and the upper electrode 303 can be reflected on the basis of the provision of the reflection mirror 308, it is possible to enhance a thermal efficiency, however, it is not an essential structure of the present invention.

Further, a protection quartz plate 307 is arranged between the lower electrode 302 and the upper electrode 303, and the reflection mirror 308. The protection quartz plate 307 has a function of preventing the surface of the reflection mirror 308 from being contaminated by a discharged material (a sublimation of a graphite) from the upper electrode 303 and the lower electrode 302 which are at an ultra-high temperature, and preventing the contamination which may be mixed into the sample to be heated 301 from the reflection mirror or 308.

A sheet member having a high melting point and a low radiation rate or a coating 309 having a high melting point and a low radiation rate is arranged in an opposite side of a surface coming into contact with the plasma of the lower electrode 302. Since the radiation heat from the lower electrode 302 can be lowered on the basis of the provision of the sheet member having the high melting point and the low radiation rate or the coating 309 having the high melting point and the low radiation rate, it is possible to enhance a heat efficiency. In this case, in the case that a heating treatment temperature is low, the sheet member having the high melting point and the low radiation rate or the coating 309 having the high melting point and the low radiation rate are not necessarily provided. In the case of the ultra-high temperature treatment, it is possible to heat to a predetermined temperature on the basis of a provision of any one of the sheet member having the high melting point and the low radiation rate or the coating 309 having the high melting point and the low radiation rate and the reflection mirror 308, or on the basis of a provision of both of them. The temperature of the sample to be heated 301 is measured by a radiation temperature gauge 318. In the present embodiment, a sheet member obtained by coating TaC (a tantalum carbide) on the graphite base material is used for the sheet member having the high melting point and the low radiation rate or the coating 309 having the high melting point and the low radiation rate which is applied to the opposite side to the surface coming into contact with the plasma in the lower electrode 302.

Next, a description will be given of an example of a basic operation of the heat treatment apparatus in accordance with the present embodiment.

First of all, He gas within the heating treatment chamber 300 is exhausted from the exhaust port 315 so as to form a high vacuum state. In such a state that the exhaust air is sufficiently finished, the exhaust port 315 is closed, the gas is introduced from the gas introducing means 313, and the pressure in the heating treatment chamber 300 is set to 0.6 atm. In the present embodiment, He gas is employed for the gas which is introduced into the heating treatment chamber 300. The sample to be heated 301 which is preheated at 400° C. in a preheating chamber (not illustrated) is mounted from a carrier port 317 on the upper electrode 303 which corresponds to a heating plate, by a carrier means which is not illustrated.

After the sample to be heated 301 is mounted onto the upper electrode 303, the heating of the sample to be heated 301 is carried out by feeding the radio-frequency power from the radio-frequency power supply 311 to the lower electrode 302 via the matching circuit 312 and a power introduction terminal 306, and creating the plasma within the gap 304. An energy of the radio-frequency power is absorbed by an electron within the plasma, and an atomic element or a molecule of a raw material gas is heated by a collision of the electrons. Further, an ion generated by an ionization is accelerated by an electric potential difference which is generated in a sheath on the surface which comes into contact with the plasma in the lower electrode 302 and the upper electrode 303, and enters into the lower electrode 302 and the upper electrode 303 while coming into collision with the raw material gas. In the collision process, it is possible to raise the temperature of the gas which is filled between the upper electrode 303 and the lower electrode 302 and the temperature of the surface between the lower electrode 302 and the upper electrode 303.

Particularly, in the vicinity of the atmospheric pressure such as the present embodiment, since the ion comes into collision with the raw material gas frequently at a time when the ion passes through the sheath, there can be thought that it is possible to efficiently heat the raw material gas which is filled between the upper electrode 303 and the lower electrode 302. As a result, it is possible to easily heat the temperature of the raw material gas to about 1200 to 2000° C. On the basis of the contact of the heated high temperature gas, the upper electrode 303 and the lower electrode 302 are heated. Further, a part of a neutral gas which is excited by an electron collision gets out of an excitation while accompanying a light generation, and the upper electrode 303 and the lower electrode 302 are heated by the light generation at this time. Further, the sample to be heated 301 are heated by a circulation of the high temperature gas, a radiation from the heated lower electrode 302 and upper electrode 303, and a heat transmission from the upper electrode 303.

In this case, since the sample to be heated 301 is mounted on the upper electrode 303, the sample to be heated 301 is heated after the upper electrode 303 is heated by the high temperature gas. Therefore, it is possible to obtain an effect of efficiently and uniformly heating the sample to be heated 301.

Further, it is possible to form a electric field having a high uniformity between the lower electrode 302 and the upper electrode 303 so as to create a uniform plasma regardless of the shape of the sample to be heated 301, by mounting the sample to be heated 301 to the side which does not come into contact with the plasma in the upper electrode. Further, the sample to be heated 301 is not directly exposed to the plasma which is formed in the gap 304, by mounting the sample to be heated 301 on the upper electrode 303. Further, even in the case of changing from a glow electric discharge to an arc electric discharge, the electric discharge current flows to the lower electrode 302 without going through the sample to be heated 301, so that it is possible to avoid a damage applied to the sample to be heated 301.

Since the temperature of the sample to be heated 301 during the heating treatment is measured by the radiation temperature gauge 318, and an output of the radio-frequency power supply 311 is controlled by a control apparatus 319 while using a measured value in such a manner as to come to a predetermined temperature, it is possible to control the heated temperature of the sample to be heated 301 at a high precision. In the present embodiment, the input radio-frequency power is set to 20 kW to the maximum.

In order to efficiently raise the temperatures of the lower electrode 302 and the upper electrode 303 (including the sample to be heated 301), it is necessary to suppress a heat transfer of the lower feeder line 305, a heat transfer via the He gas atmosphere and a radiation from the high temperature region (a visible light region from an infrared light). Particularly, in the ultra-high temperature state equal to or higher than 1200° C., the heat dissipation by the radiation is very great, and it is essential for improving the heating efficiency to reduce a radiation loss. In this case, in the radiation loss, an amount of radiation is increased in proportion to fourth-power of an absolute temperature.

In order to suppress the radiation loss, in the present embodiment, as mentioned above, the sheet member having the high melting point and the low radiation rate or the coating 309 having the high melting point and the low radiation rate is arranged in the opposite side to the surface coming into contact with the plasma in the lower electrode 302. TaC is used for a material having a high melting point and a low radiation rate. The radiation rate of TaC is about 0.05 to 0.1, and reflects the infrared light going with the radiation at a reflection rate about 90%. In accordance with this, the radiation loss from the lower electrode 302 can be suppressed, and it is possible to set the sample to be heated 301 to the ultra-high temperature about 1200 to 2000° C. at a high heat efficiency.

The TaC is arranged in a state in which it is not exposed directly to the plasma, and is structured such that the impurity included in the Ta or the TaC is not mixed into the sample to be heated 301 during the heating treatment. Further, since a heat capacity of the TaC corresponding to the sheet member having the high melting point and the low radiation rate and the coating 309 having the high melting point and the low radiation rate is extremely small, it is possible to restrict an increase of the heat capacity of the heating portion to the minimum. In accordance with this, there is hardly generated a reduction of a temperature rising and temperature decreasing speed, by arranging the sheet member having the high melting point and the low radiation rate or the coating 309 having the high melting point and the low radiation rate.

Further, it is possible to create the plasma which is expanded uniformly between the lower electrode 302 and the upper electrode 303, by forming a plasma created between the upper electrode 303 and the lower electrode 302 as a plasma in a glow electric discharge region, and it is possible to uniformly heat a two-dimensional sample to be heated 301 by heating the sample to be heated 301 by using the two-dimensional plasma as a heat source.

Further, since it is possible to two-dimensionally and uniformly heat up, there is a low risk that a breakage or the like going with the temperature unevenness within the sample to be heated 301 is generated even by raising the temperature rapidly. Accordingly, it is possible to achieve a temperature rise and a temperature down at a high speed, and it is possible to shorten a time which is necessary for a series of heating treatments. On the basis of this effect, it is possible to improve a throughput of the heating treatment, it is possible to inhibit the sample to be heated 301 from staying in the high temperature atmosphere more than necessary, and it is possible to reduce the SiC surface roughing going with the high temperature.

After the heating treatment mentioned above is finished, the temperature of the sample to be heated 301 is lowered to come to 800° C. or lower, the sample to be heated 301 is carried out of the carrier port 317, the next sample to be heated 301 is mounted on the upper electrode 303 by a carrying means (not illustrated), and a series of operations of the heating treatment are repeated.

It is possible to reduce a used amount of the He gas without carrying out a replacement of the He gas within the heating treatment chamber 300 going with the replacement of the sample to be heated 301, by keeping a gas atmosphere at a sample to be heated retracting position (not illustrated) which is connected to the carrier port 317 at the same level as that within the heating treatment chamber 300, at a time of replacing the sample to be heated 301. Of course, since a purity of the He gas within the heating treatment chamber 300 may be lowered by repeating the heating treatment to some extent, the replacement of the He gas is executed periodically at that time.

In the case that the He gas is used for the plasma creating gas, the He gas is a comparatively expensive gas, so that a running cost can be held down by reducing the used amount of the He gas as much as possible. This can be applied to the amount of the He gas which is introduced during the heating treatment, and it is possible to reduce the used amount of the He gas by setting a minimum flow rate for keeping the gas purity of the He gas during the heating treatment.

Further, a cooling time of the sample to be heated 301 can be shortened by introducing the He gas. In other words, it is possible to shorten the cooling time on the basis of the cooing effect of the He gas by increasing the flow rate of the He gas after the heating treatment is finished (the plasma stops).

In this case, in the present embodiment, the sample to be heated 301 is carried out in a state of being equal to or less than 800° C., however, even if the sample to be heated 301 is in a state between 800° C. and 2000° C., it is possible to carry out by using a carrier arm having a high heat resistance, whereby it is possible to shorten a standby time.

In the basic motion of the heat treatment apparatus in accordance with the present embodiment, the gap 304 is set to 0.8 mm, however, the same effect can be achieved even in a range between 0.1 mm and 2 mm. The plasma creation can be achieved even in the case that the gap is narrower than 0.1 mm, however, a high precision structure is necessary for maintaining a degree of parallelization between the lower electrode 302 and the upper electrode 303. Further, since a surface transformation (a surface roughing or the like) of the lower electrode 302 and the upper electrode 303 is going to affect the plasma, this is not preferable. On the other hand, in the case that the gap 304 goes beyond 2 mm, a reduction of a flammability of the plasma or a radiation loss increase between the gaps come into question, and this is not preferable.

In the basic motion of the heat treatment apparatus in accordance with the present embodiment, the pressure for creating the plasma is set to 0.6 atm, however, it may be a range which is equal to or less than 10 atm. In this case, if the pressure goes beyond 10 atm, it is hard to create the uniform glow electric discharge.

In the basic motion of the heat treatment apparatus in accordance with the present embodiment, the He gas is used for the raw material gas for creating the plasma, however, it goes without saying that the same effect can be achieved even by using a gas including an inert gas such as an Ar gas, an Xe gas, a Kr gas or the like as a main raw material. Since the He gas used in the present embodiment is excellent in a plasma flammability and a stability in the vicinity of the atmospheric pressure, however, the coefficient of thermal conductivity of the gas is high, a heat loss caused by the heat transfer via the gas atmosphere is comparatively great. On the other hand, in the gas having a great mass such as the Ar gas, the Xegas, the Kr gas or the like, since the coefficient of thermal conductivity is low, it is advantageous in the light of the heat efficiency.

In the present embodiment, the sheet material obtained by coating the TaC (tantalum carbide) on the graphite base material is used for the sheet member having the high melting point and the low radiation rate or the coating 309 having the high melting point and the low radiation rate, which is applied to the opposite side to the surface coming into contact with the plasma in the lower electrode 302, however, it is possible to employ WC (tungsten carbide), MoC (molybdenum carbide), Ta (tantalum), Mo (molybdenum), or W (tungsten).

In the present embodiment, there is employed the graphite obtained by coating the silicon carbide in accordance with the CVD method on the opposite side to the surface which comes into contact with the plasma in the lower electrode 302, however, the same effect can be obtained by using a graphite simple substance, a member coating a pyrolytic carbon on the graphite, a member vitrifying the graphite surface, and SiC (sintered body, a polycrystal, a single crystal). In the coating applied to the graphite coming to the base material of the lower electrode 302 or its surface, one having a high purity is desirable in the light of preventing the contamination to the sample to be heated 301.

Further, at a time of the ultra-high temperature, there is a case that the contamination to the sample to be heated 301 affects from the lower feed line 305. Accordingly, in the present embodiment, the same graphite as the lower electrode 302 is used in the lower feed line 305. Further, the heat of the lower electrode 302 is transferred to the lower feed line 305 so as to come to a loss. Accordingly, it is necessary to minimize the heat transfer from the lower feed line 305.

In accordance with this, it is necessary to make the cross sectional area of the lower feed line 305 which is formed by the graphite as small as possible, and make the length thereof long. However, if the cross sectional area of the lower feed line 305 is made extremely small, and the length is made too long, the radio-frequency power loss in the lower feed line 305 becomes large, thereby causing a reduction of a heating efficiency of the sample to be heated 301. In accordance with this, in the present embodiment, the cross sectional area and the length of the lower feed line 305 formed by the graphite are respectively set to 12 mm², and 40 mm, however, the cross sectional area and the length of the lower feed line 305 may be respectively set to be between 5 mm2 and 30 mm², and between 30 mm and 100 mm.

In the present embodiment, it is possible to obtain an improvement of the heating efficiency by returning the radiation light to the upper electrode 303 and the lower electrode 302 by the reflection mirror 308 as well as reducing the radiation loss from the lower electrode 302 by the sheet member having the high melting point and the low radiation rate or the coating 309 having the high melting point and the low radiation rate. However, it goes without saying that it is possible to expect the improvement of the heating efficiency, even in the case that only the sheet member having the high melting point and the low radiation rate or the coating 309 having the high melting point and the low radiation rate is provided. In the same manner, even in the case that only the reflection mirror 308 is arranged, it is possible to expect the improvement of the heating efficiency. Further, since the protection quartz plate 307 is arranged for expecting the effect of preventing the contamination, it is possible to obtain a sufficient heating efficiency without using the protection quartz plate 307.

In the present embodiment, the heat dissipation of the lower electrode 302 and the upper electrode 303, which affects the heating efficiency as mentioned above is mainly constructed by (1) the radiation, (2) the heat transmission of the gas atmosphere and (3) the heat transmission from the lower feeder line 305. In the case that the heating treatment is carried out at 1200° C., the main factor of the heat dissipation among them is (1) the radiation.

In order to suppress (1) the radiation, the sheet member having the high melting point and the low radiation rate or the coating 309 having the high melting point and the low radiation rate is provided in an opposite side to the surface which comes into contact with the plasma in the lower electrode 302. Further, the heat dissipation from the lower feeder line 305 in the item (3) is minimized by optimizing the cross sectional area and the length mentioned above.

Further, with regard to the item (2) the heat transmission of the gas atmosphere, it is suppressed by optimizing a heat transmission distance of the gas. In this case, the heat transmission distance of the gas means a distance from the lower electrode 302 and the upper electrode 303 thereof which correspond to the high temperature portion to the protection quartz plate 307 which corresponds to the low temperature portion or the wall of the heating treatment chamber 300 which corresponds to the low temperature portion.

Since the heat transmission rate of the He gas is high in the He gas atmosphere in the vicinity of the atmospheric pressure, the heat dissipation by the heat transmission of the gas becomes comparatively higher. Accordingly, in the present embodiment, it is structured such as to secure 30 mm or more in the distance from the lower electrode 302 to the protection quartz plate 307 or from the lower electrode 302 to the reflection mirror 308. In the same manner, it is structured such as to secure 30 mm or more in the distance from the upper electrode 303 to the protection quartz plate 307 or from the upper electrode 303 to the reflection mirror 308. The longer heat transmission distance of the gas is advantageous for suppressing the heat dissipation, however, the magnitude of the reflection mirror 308 becomes larger with respect to the heating region, and this is not preferable. By making the heat transmission distance of the gas equal to or more than 30 mm, it is possible to suppress the heat dissipation caused by the heat transmission of the gas atmosphere while suppressing the magnitude of the heating treatment chamber 300. Of course, it goes without saying that it is possible to further suppress the heat dissipation caused by the heat transmission of the gas atmosphere by using the Ar gas, the Xe gas, the Kr gas or the like having the low coefficient of thermal conductivity.

In the present embodiment, the radio-frequency power supply of 13.56 MHz is used for creating the plasma, however, this is because 13.56 MHz is an industrial frequency and the power supply can be obtained at a low cost, and since an electromagnetic wave leakage standard is low, a cost for the heat treatment apparatus can be reduced. However, in principle, it goes without saying that the plasma heating can be carried out in accordance with the same principle in the other frequency. Particularly, the frequency which is equal to or more than 1 MHz and equal to or less than 100 MHz is preferable.

If the frequency becomes lower than 1 MHz, the radio-frequency voltage at a time of feeding the radio-frequency electric power which is necessary for the heating becomes high, there is generated an abnormal electric discharge (an unstable electric discharge or the other electric discharge than one between the upper electrode 303 and the lower electrode 302), a stable operation becomes hard, and this is not preferable. Further, in the frequency which goes beyond 100 MHz, since an impedance between the gaps 304 of the lower electrode 302 and the upper electrode 303 is low, and the electric voltage which is necessary for creating the plasma is hard to be obtained, this is not desirable.

Further, in the present embodiment, since the lower electrode 302 and the upper electrode 303 are fixed, the gap 304 does not fluctuate. In accordance with this, it is possible to create a stable plasma every time of the heating treatment of the sample to be heated 301.

As a result that the heating treatment for one minute is carried out at 1500° C., in the SiC substrate in which the ion implantation is carried out by using the heat treatment apparatus in accordance with the present embodiment, a good conducting property can be obtained. Further, the surface roughing is not seen on the surface of the SiC substrate.

The effect of the present invention shown in the present embodiment will be arranged below. In the heating treatment in accordance with the present invention, the sample to be heated 301 is heated by using the gas heating caused by the atmospheric pressure glow electric discharge which is created in the narrow gap as the heat source. It is possible to obtain four effects which are not provided by the prior art and shown below, in accordance with the present heating principle.

A first point is a heat efficiency. The heat capacity of the gas in the gap 304 is extremely small, and it is possible to heat the sample to be heated 301 in accordance with the system in which the heating loss going with the radiation is extremely small, by arranging the sheet member having the high melting point and the low radiation rate or the coating 309 having the high melting point and the low radiation rate in the lower electrode 302.

A second point is a heating response and a uniformity. Since the heat capacity of the heating portion is extremely small, rapid temperature increase and decrease can be achieved. Further, since the gas heating caused by the glow electric discharge is used for the heating source, it is possible to achieve a two-dimensionally uniform heating on the basis of an expansion of the glow electric discharge. Since the temperature uniformity is high, it is possible to suppress the device characteristic dispersion in the surface of the sample to be heated 301 going with the heating treatment, and it is possible to suppress a damage due to a thermal stress going with the temperature difference within the surface of the sample to be heated 301 at a time of carrying out the rapid temperature increase or the like.

A third point is a reduction of the consumed parts going with the heating treatment. In the present invention, since the gas coming into contact with each of the upper electrode 303 and the lower electrode 302 is directly heated, the high temperature forming area is limited to the member which is arranged extremely in the vicinity of the upper electrode 303 and the lower electrode 302, and the temperature thereof is equal to the sample to be heated 301. Accordingly, a service life of the member is short, and the area of replacement going with the parts deterioration is small.

A fourth point is a suppression of the surface roughing of the sample to be heated 301. In the present invention, since the temperature increasing and decreasing times can be made short on the basis of the previously described effect, it is possible to shorten a time for which the sample to be heated 301 is exposed to the high temperature environment to the minimum. Accordingly, it is possible to suppress the surface roughing. Further, in the present invention, the plasma caused by the atmospheric pressure glow electric discharge is used as the heating source, however, the sample to be heated 301 is not directly exposed to the plasma. In accordance with this, forming and removing steps of the protection film which are carried out by the different apparatus from the heat treatment apparatus is not necessary, and it is possible to reduce a manufacturing cost of the semiconductor device using the SiC substrate.

As mentioned above in each of the embodiments, the present invention can be said to be the heat treatment apparatus which indirectly heats the sample to be heated by using the plasma caused by the glow electric discharge as the plasma. Further, in other words, the present invention can be said to be the heat treatment apparatus provided with the heating treatment chamber which heats the sample to be heated, characterized in that the heating treatment chamber is provided with the heating plate, the electrode which is opposed to the heating plate, and the radio-frequency power supply which feeds the radio-frequency power for creating the plasma to the electrode, the plasma caused by the glow electric discharge is created between the electrode and the heating plate, and the sample to be heated is indirectly heated by using the plasma caused by the glow electric discharge which is created between the electrode and the heating plate as the heating source.

Therefore, in accordance with the present invention, it is possible to achieve the effects mentioned above in each of the embodiments.

It should be further understood by those skilled in the art that although the foregoing description has been made on embodiments of the invention, the invention is not limited thereto and various changes and modifications may be made without departing from the spirit of the invention and the scope of the appended claims.

1. A heat treatment apparatus comprising:
a heating treatment chamber for heating a sample to be heated;
a heating plate for heating the sample to be heated and disposed in said heating treatment chamber;
a plate electrode disposed in said heating treatment chamber and being opposed to said heating plate;
a radio-frequency power supply supplying a radio-frequency power to said plate electrode and generating a plasma between said plate electrode and said heating plate; and
a sample stage supporting the sample to be heated and being disposed below to said heating plate.

2. The heat treatment apparatus as claimed in claim 1, wherein said heating plate comprises:
a member being circular plate; and
a beam provided in outer periphery of the member and supporting the member.

3. The heat treatment apparatus as claimed in claim 2,
further comprising a reflection mirror reflecting radiation heat, wherein said heating plate is conducted with the reflection mirror via the beam.

4. The heat treatment apparatus as claimed in claim 3, wherein said heating plate is grounded via the reflection mirror.

5. The heat treatment apparatus as claimed in claim 1, wherein said sample stage comprises radiation heat suppressing means.

6. The heat treatment apparatus as claimed in claim 5, wherein the radiation heat suppressing means is constructed by a sheet material which has a high melting point and a low radiation rate or a coating which has a high melting point and a low radiation rate.

7. The heat treatment apparatus as claimed in claim 5, wherein said heating plate comprises:
a member being a circular plate; and
a beam provided in an outer periphery of said member and supporting said member.

8. The heat treatment apparatus as claimed in claim 7,
further comprising a reflection mirror reflecting radiation heat, wherein said heating plate is conducted with said reflection mirror via said beam.

9. The heat treatment apparatus as claimed in claim 8, wherein said heating plate is grounded via said reflection mirror.

10. The heat treatment apparatus as claimed in claim 1, wherein said sample stage has a graphite substrate.
